(19) United States
(12) Patent Application Publication
(10) Pub. No.: US 2024/0356652 A1
(43) Pub. Date: Oct. 24, 2024

(54) LIGHT SOURCE MULTIPLEXING FOR MODULATED OPTICAL COMMUNICATION

(71) Applicant: SIGNIFY HOLDING B.V., EINDHOVEN (NL)

(72) Inventor: CHRISTOPH GERARD AUGUST HOELEN, VALKENSWAARD (NL)

(21) Appl. No.: 18/683,572

(22) PCT Filed: Aug. 12, 2022
(86) PCT No.: PCT/EP2022/072682

§ 371 Date: Feb. 14, 2024

(30) Foreign Application Priority Data
Aug. 17, 2021 (EP) 21191608.5

(51) Int. Cl. H04B 10/516; H04B 10/50

(52) U.S. Cl. CPC H04B 10/516; H04B 10/502; H04B 10/504

(57) ABSTRACT

This invention relates to a transmitter and transmission system for optical communication that comprises multiplexing of light sources with serial emission of data and protocol negotiation signals to enable binary pulse modulation with miniaturized components. Mounting two different light sources (e.g., VCSELs) antiparallel enables multiplexing functionality while requiring only a two-electrodes package without further inclusion of Zener diodes, resulting in miniaturization and cost reduction.

### FIELD OF THE INVENTION

The invention relates to the field of signal transmission in optical communication networks, such as—but not limited to—LiFi networks, for use in various applications for home, office, retail, hospitality and industry.

### BACKGROUND OF THE INVENTION

Optical wireless communication (OWC) systems, such as LiFi networks (named like WiFi networks), enable mobile user devices (called end points (EP) in the following) like laptops, tablets, smartphones or the like to connect wirelessly to the internet. WiFi achieves this using radio frequencies, but LiFi achieves this using the light spectrum which can enable unprecedented data transfer speed and bandwidth. Furthermore, it can be used in areas susceptible to electromagnetic interference. An important point to consider is that wireless data is required for more than just our traditional connected devices. Today, televisions, speakers, headphones, printer's, virtual reality (VR) goggles and even refrigerators use wireless data to connect and perform essential communications. Radio frequency (RF) technology like WiFi is running out of spectrum to support this digital revolution and LiFi can help power the next generation of immersive connectivity. Based on modulations, information in the coded light can be detected using any suitable light sensor. This can be a dedicated photocell (point detector), an array of photocells possibly with a lens, reflector, diffuser of phosphor converter, or a camera comprising an array of photocells (pixels) and a lens for forming an image on the array. E.g., the light sensor may be a dedicated photocell included in a dongle which plugs into the end point. Either way this may enable an application running on the end point to receive data via the light.

In LiFi systems, electromagnetic radiation (e.g., in the visible or near infrared (NIR) part of the spectrum) is high-frequency modulated to transmit data at high data rates. For the downstream link, data flows from one or several electro-optical emitters comprised in an access point (AP) in the ceiling (e.g., integrated in a luminaire) via a wide beam of modulated radiation to a receiver at the location of an end-user. This receiver may be a dongle that is connected via a Universal Serial Bus (USB) interface with a computer. For the upstream link, an electro-optical emitter located in the dongle emits a wide beam of modulated radiation that in turn is received by one or more opto-electrical sensors in the access point in the ceiling. Many LiFi communication systems use optical Orthogonal Frequency-Division Multiplexing (OFDM) as a modulation scheme, but there is a need to enable LiFi systems complying with e.g. the USB communication protocol. This may be required for e.g. point-to-point communication between portable devices such as mobile phones, or between a mobile phone and a device connected to the infrastructure such as a television (TV) or a hub. Specifically for mobile device integration, miniaturization is extremely demanding.

As an example, on-off keying (OOK) or 2-level pulse amplitude modulation (PAM-2) could be attractive modulation schemes for LiFi systems requiring low power dissipation, as the modulation and demodulation principles are very simple, thereby enabling modulation/demodulation without the need for complex algorithms that would require additional calculation power and components. Specifically, when using lasers or laser diodes, thanks to their large modulation bandwidth, which is more than an order of magnitude larger than for light emitting diodes (LEDs), high data rates are enabled while still using this simple OOK or PAM-2.

European patent application EP1641151 A1 discloses a method and device for generating four-level optical signal rather than a binary optical signal in order to lower the bit-rate, it proposes to use two two-level electrical coded signals to drive two optical modulators, that e.g. modulate a laser output, thereby generating two different optical coded signals and coupling these two optical signals at an optical coupler to obtain a four-level optical signal. To improve the combination the coupling ratio and power of the optical signals are adjusted to achieve a good extinction ratio of the four-level optical signal.

The USB protocol or other interface protocols define the use of multiple pins and multiple states, handling of protocol negotiation signals and data signals would also require multi-level amplitude modulation (such as PAM-3 or PAM-4). This in turn would severely reduce system efficiency, as the power emission capability would need to be at least doubled, resulting in at least a doubling of the additional losses due to the presence of the lasing threshold current, and would increase complexity particularly at the receiver side due to the required discrimination between multiple amplitude levels. Both factors lead to increased cost, increased volume, and increased power consumption.

### SUMMARY OF THE INVENTION

It is an object of the present invention to provide a transmission scheme for optical wireless communication, that allows handling of protocol negotiation signals and data signals while still modulating emitters with a two-level (binary) modulation scheme.

This object is achieved by a transmitter as claimed in claim 1, a system as claimed in claim 10 and a method as claimed in claim 12.

According to a first aspect directed to a transmission end of the system, a transmitter is provided for transmitting multiplexed optical signals in an optical communication system, wherein the transmitter comprises:
two semiconductor light sources and an apparatus is provided for transmitting data via an optical link,
the apparatus comprising:
an encoder for converting input data into a plurality of signaling states of a communication or interface protocol; and
a driver for generating at least one modulated driving signal with a plurality of modulation levels mapped to the plurality of signaling states and for supplying the at least one modulated driving signal to the two light sources, wherein the modulated driving signal is configured to drive the two light sources with different ones of the plurality of modulation levels, in a mutually exclusive manner, such that only one of the light sources emits at a time.

According to a second aspect a system is provided for transmitting data via an optical link, the system comprising:
a transmitter in accordance with the first aspect; and
an apparatus for receiving the data via the optical link, the apparatus comprising:
a detector for detecting multiplexed optical signals with the different ones of the plurality of modulation levels and for extracting the plurality of modulation levels; and
a demodulator for converting the plurality of modulation levels into the plurality of signaling states of the communication or interface protocol mapped to the plurality of modulation levels.

The apparatus fore receiving the data via the optical link may be part of a receiver.

According to a third aspect, a method is provided of transmitting data via an optical link, the method comprising:
converting input data into a plurality of signaling states of a communication or interface protocol;
generating at least one modulated driving signal with a plurality of modulation levels mapped to the plurality of signaling states; and
supplying the at least one modulated driving signal to two semiconductor light sources, wherein the modulated driving signal is configured to drive the two light sources with different ones of the plurality of modulation levels in a mutually exclusive manner, such that only one of the light source emits at a time.

Accordingly, increased system efficiency and reduced complexity can be achieved by reducing power emission capability at the transmitter and reducing discrimination capability at the receiver due to a split of modulation levels among the two light sources. Both factors lead to reduced cost, reduced volume, and reduced power consumption. The driver is configured to drive the two light sources with the modulated drive signal in a mutually exclusive manner. Thereby, only one of the light sources emits at a time so that power consumption, interference and discrimination effort can be further reduced, which is particularly relevant for first option described next.

It is noted that the proposed light source multiplex transmission scheme also works well for transmission over optical fibers (e.g. polymer optical fibers (POFs)) which allow small and thus fast detectors and where transmitter limitations are relevant. Thereby, higher bit rates at low complexity and low power consumption can be achieved for semiconductor light sources (e.g. LEDs or laser diodes) over optical fibers as well.

According to a first option of any of the aspects, the two light sources may be configured to generate respective light outputs with different wavelength or polarization, when using polarization in particular circular polarization is beneficial. Thereby, dual-stage detection of two respective levels is enabled at the receiver, which is advantageous e.g. in mobile configurations where the distance and relative orientations of the devices change, resulting in large variations of absolute signal levels at the receiver.

According to a second option of any of the aspects, which can be combined with the first option, the two light sources are selected from: light emitting diodes (LEDs), micro LEDs, vertical cavity surface emitting lasers, edge emitting lasers, edge emitting laser didoes, and photonic crystal surface emitting lasers. Preferably the light sources are similar, for example, both are VCSELs, but may e.g. use different wavelengths (when combined with the first option).

According to a third option of any of the aspects, which can be combined with the first or second option, the two light sources may be connected in an antiparallel configuration with two connectors for applying the modulated drive signal to both of the two light sources. The antiparallel configuration provides a polarity-addressable dual channel laser diode configuration enabling wavelength or polarization multiplexing via serial emission of the states of the communication or interface protocol, while securing electrostatic discharge (ESD) protection, minimization of component count, and minimization of electrodes count. The polarity of a multi-level (bipolar) driving signal can be used to determine which light source, and when combined with the first option, which wavelength or polarization channel is activated.

According to a fourth option of any of the aspects, when combined with the third option, the antiparallel configuration may be implemented using a vertical chip architecture (using a single wire-bonded electrode), a lateral chip architecture (using two wire-bonded electrodes), or a flip-chip architecture (without use of wire bonds), mounted on a suitable substrate such as a ceramic board, an insulated metal substrate (IMS) or metal core printed circuit board (MC-PCB), a glass-reinforced epoxy based PCB such as FR-4, a cotton paper and epoxy based PCB such as CEM-2, a polymer (e.g. polyimide) based flex PCB or a flex-rigid PCB, or mounted in a package such as a flat no leads package (QFN), a plastic leaded chip carrier (PLCC) or a ceramic or ceramic-substrate package. Thereby, a compact transmitter architecture can be achieved. In the vertical chip architecture, one of the electrodes of the chip is connected via a bond-wire, the other via a direct electrical interconnect such as a solder or an electrically conductive interface material between chip and substrate (such as a conductive glue, e.g. a silver paste glue). Horizontal or lateral chip architectures have both electrodes connected via respective bond-wires. In the latter case, the interconnect between chip and substrate can be purely thermo-mechanical so that electrical conductivity is not relevant. Use of an emitter package gives the advantage of ease of handling and enabling the use of a PCB with more relaxed resolution requirements.

According to a fifth option of any of the aspects, when combined with the third or fourth option, the plurality of signaling states of the communication or interface protocol may be used to enable driving of each of the light sources using only two power levels for generating protocol negotiation signals and data transfer signals. Thus, the compact and efficient transmission system can be used for providing various communication or interface protocols via optical links.

In an example of the fifth option, the communication or interface protocol may be a USB protocol. In this case, the plurality of signaling states may comprise at least some of a J state, a K state, a SE0 state, and an Init state of the USB protocol, and preferably all four states.

According to a sixth option of any of the aspects the modulated drive signal may be generated by using a three-level modulation scheme where both light sources are driven in an OOK mode, or or a three-level non-return-to-zero (NRZ) modulation scheme where one of the two light sources is driven in an NRZ PAM-2 mode and the other of the two light sources is driven in the OOK mode, or a four-level NRZ modulation scheme where both light sources are driven in the NRZ PAM-2 mode. Thus, various implementation options for splitting different numbers of states among the two light sources can be provided.

According to a seventh option, the received multiplexed optical signals may be wavelength or polarization multiplexed optical signals. This provides the advantage that output levels of the two light sources can be better discriminated.

It is noted that the above apparatuses may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the transmitter as claimed in claim 1, the system as claimed in claim 10 and the method as claimed in claim 12 may have similar and/or identical preferred embodiments, in particular, as defined in the dependent claims. In particular it is envisaged that the claimed apparatuses, or the respective transmitters/receivers using such apparatuses, may be used in systems to realize optical data communication.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically a block diagram of an optical communication system with wavelength/polarization multiplexing according to various embodiments;

FIG. 2 shows a flow diagram of transmission procedure with wavelength/polarization multiplexing according to various embodiments;

FIG. 3 shows a flow diagram of a reception procedure with wavelength/polarization multiplexing;

FIG. 4 shows schematically a dual channel emitter with antiparallel laser diodes according to an embodiment;

FIG. 5 shows schematically a diagram of a 2-level non-return-to-zero pulse amplitude modulation for driving a laser diode;

FIG. 6 shows schematically a diagram of an OOK amplitude modulation for driving a laser diode;

FIG. 7 shows top views of three lay-out examples of two laser diode chips configured in an anti-parallel configuration according to various embodiments;

FIG. 8 shows schematically a diagram of a modulation scheme according to an embodiment where both laser diodes are driven in OOK mode;

FIG. 9 shows schematically a diagram of a first example of a 3-level non-return-to-zero (NRZ) modulation scheme according to an embodiment where one of the laser diodes is driven in PAM-2 (NRZ) and the other laser diode is driven in OOK mode;

FIG. 10 shows schematically a diagram of a second example of a 3-level NRZ modulation scheme according to an embodiment where one of the laser diodes is driven in PAM-2 (NRZ) and the other laser diode is driven in OOK mode;

FIG. 11 shows schematically a waveform diagram of an example of a high-speed USB 2.0 negotiation procedure between a host and a device; and

FIG. 12 shows schematically a diagram of 4-level NRZ modulation scheme where both laser diodes are driven in PAM-2 (NRZ) mode.

### DETAILED DESCRIPTION OF EMBODIMENTS

Various embodiments of the present invention are now described based on a transmission system for an optical wireless illumination and communication (LiFi) system with multiplexed channels. Although the present invention is particularly advantageous within the context of an illumination system, the invention is not limited thereto and may also be used within an optical wireless communication system that is not integrated within an illumination system or within a fiber-based optical communication system.

Throughout the following, a light source or emitter may be understood as a radiation source that generates visible or non-visible light (i.e., including infrared (IR) or ultraviolet (UV)) light sources) for communication purposes. The light source may be included in a luminaire, such as a recessed or surface-mounted incandescent, fluorescent or other electric-discharge luminaires. Luminaires can also be of the non-traditional type, such as fiber optics with the light source at one location and the fiber core or “light pipe” at another. The concepts can also be used in peer-to-peer communication between smartphones or Internet of Things (IoT) devices.

It is further noted that when using optical wireless communication based on invisible parts of the light spectrum, such as infrared and/or or ultraviolet, the system can be fully decoupled from any illumination systems. In such scenarios the optical wireless communications systems may function to primarily provide communication and a separate transceiver node may be used in the optical wireless communication system. Alternatively, such optical wireless communication systems may be complementary to a further function and thus be integrated in other application devices that benefit from such communication functionality; such as personal computers, personal digital assistants, tablet computers, mobile phones, televisions, etc.

Conventional light source luminaires are rapidly being replaced by light emitting diode (LED) or laser-based lighting solutions. In LiFi systems, more advanced LED or laser-based luminaires are enabled to act as LiFi communications hub to add LiFi connectivity to lighting infrastructure. The underlying idea is that an illumination infrastructure is positioned in such a manner that it provides a line of sight from the luminaire to locations where people tend to reside. As a result, the illumination infrastructure is also well positioned to provide optical wireless communication that likewise requires line of sight.

According to various embodiments, an optical transmission system comprising a (power) transmitter and a receiver is presented, that allows wavelength multiplexing with serial emission of data and protocol negotiation signals to enable PAM-2 or OOK modulation with miniaturized components and minimized power consumption. With two different wavelengths or polarizations of emission, the negotiation and the data transfer can be handled by these two wavelength or polarization channels respectively, each of which can be modulated using only two power levels.

More specifically, an optical front end having a pair of light sources (e.g., LEDs, micro LEDs, vertical cavity surface emitting lasers (VCSELs), edge emitting lasers (EELs), edge emitting laser diodes (EELDs), photonic crystal surface emitting lasers (PCSELs), etc.) each having a different wavelength or polarization can be driven by one or more drivers (modulators) which can drive negative and positive currents having imposed thereon a modulated data signal. The modulated data signal may correspond with signaling states of a communication or interface protocol (e.g., USB 2.0 bus states) that are mapped onto discrete output levels of the two light sources, wherein one or both signal sources may be emitting at any one time.

It is noted that in a true anti-parallel configuration, the two light sources cannot emit at the same time due to their diode nature. However, in a three-terminal configuration where only one of the electrodes of both light sources are directly galvanically connected to each other forming a joint terminal (i.e., a serial configuration) with opposite polarity of the two sources, both light sources can emit at the same time.

In an example where an USB communication protocol is used for optical wireless communication, two signal levels are not enough to comply with the standard. As a result, higher-level modulation types, such as PAM-3 or PAM-4 modulation, would be needed, resulting in hugely increased required power emission capability of the system, which is incompatible with the request for low-average-power consuming systems. For the application of laser diodes, which in principle enable high speed communication using simple modulation thanks to their large intrinsic modulation bandwidth, this is causing issues due to the presence of the lasing threshold current, which asks for a tuned power capability of the emitter versus the targeted power emission level of the system.

In general, there is a limited drive current range in which a laser diode, such as a VCSEL, operates at maximum efficiency. When reducing the drive current, the electro-optical conversion efficiency rapidly collapses due to the presence of the laser threshold current, close to which there is mainly thermal dissipation and hardly optical output power available.

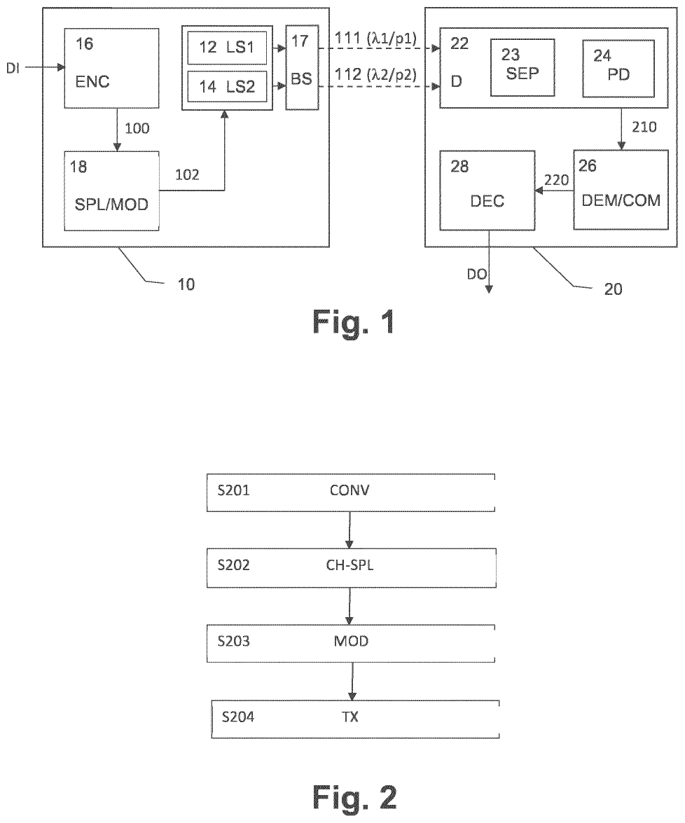

FIG. 1 shows schematically a block diagram of an optical communication system with wavelength/polarization multiplexing according to various embodiments.

It is noted that-throughout the present disclosure-only those structural elements and functions are shown, which are useful to understand the embodiments. Other structural elements and functions are omitted for brevity reasons.

The optical communication system of FIG. 1 may correspond to a communication link of a LiFi network and comprises a transmitter (optical emitter) 10 (e.g., as part of an access point (AP) with a luminaire of a lighting system) connected via an optical link (e.g., an optical free-space link) to a receiver (light detector) 20. Respective light signals (e.g., light beam) 111, 112 with different wavelengths l1, l2 or polarizations p1, p2 are generated by a pair of light sources (LS1, LS2) 12, 14 of the transmitter 10 and are received by a detector (D) 22 of the receiver 20. In case polarization is used in combination with mobile transmitters and/or receivers, circular polarization is preferred as it does is less susceptible to alignment errors.

The pair of light sources 12, 14 may be radiation emitting elements (e.g., LEDs, laser diodes (VCSELs), or other types of lasers) and may be followed by an optional beam shaping element (BS) 17 which may be a shared optic or individual optics associated with each of the light sources 12, 14, substantially emitting in the same direction.

The detector 22 may comprise at least one separator element (SEP) 23 (e.g., separating optics) and photo detector (PD) 24 and an optional condenser (not shown) (e.g. condensing optics, not shown), which may be shared optics or individual optics per detector element of the photo detector 24. These optics may be fully or partly integrated with the detector elements. When using multiple detector elements, they will detect light originating from substantially the same direction.

In a specific example, the photo detector 24 of the receiver 20 may comprise two opto-electric detector elements that convert the two light signals 111, 112 into respective electrical signals or at least one electrical signal 210 that represents modulation levels of the two light signals 111, 112. I.e., the received light signals 111, 112 may be first separated by the separator element 23 and then detected and converted by the photo detector 24 into (a) respective electrical signal(s). The photo detector 24 may comprise at least one radiation detecting element (e.g., a photo diode or a set of photo diodes, discrete or integrated, e.g. as a 1D or 2D array, or other type of light detector). Examples for such detection elements may be PN photodiodes (PN PDs), PiN photodiodes (PiN PDs), avalanche photodiodes (APDs), phototransistors (PTs), and silicon photomultipliers (SiPMs).

In another example, both light signals 111, 112 might first be detected by a single photo detector 24 and converted into a single electric signal 210 which comprises the modulation levels of both light signals 111, 112. The separator element 23 may then be used to discriminate or extract the modulation levels of the received light signals 111, 112. In this case, level separation at the detector 20 requires different reception levels, which may be achieved by a photo detector 24 that shows substantially different sensitivity for the two different types of light, or by a modulation of each of the two light sources with a modulation scheme that generates different output levels for each signal state to be transmitted.

In case of wavelength multiplexing, the different wavelengths l1, l2 may be obtained directly by different configurations of the light sources 12, 14 or by splitting the output beams of the light sources 12, 14 into their wavelength components by one or more wavelength-sensitive filters such as dichroic filters or spectral absorption/transmission filters.

In case of polarization multiplexing, the different polarizations p1, p2 may be obtained by filtering a beam of light of undefined or mixed polarization generated by the light sources 12, 14 into a beam of well-defined polarization using a polarizer. The two light sources 12, 14 may thus generate various polarizations from which the requested type is filtered. Alternatively, the two light sources 12, 14 may emit polarized light that is transformed by an optical component into the requested type of polarization. Thereby, substantially all the energy that was generated is also used for the emission of the light signals. E.g., a linearly polarized beam (taken here as the first type) may be transformed into the second type, being a linearly polarized beam with the polarization plane rotated by 90 degrees relative to the initial beam by an optical rotator, e.g. a half-wave plate mounted with its fast axis under an angle of 45 degrees with the incident linear polarization vector, or e.g. a left-circularly polarized beam (taken as the first type) may be transformed into a right-circularly polarized beam by passing through a half-wave plate. Alternatively, a linearly polarized emission may be transformed into circularly polarized light by e.g. a quarter-wave plate that is mounted with its fast axis under an angle of 45 degrees with the polarization vector of the incident linearly polarized light. This may then act as the first light type. The second light type may be created by mounting a quarter wave plate that is rotated by 90 degrees relative to the plate used for creating the first type of light, and the resulting handedness of the circular polarization is opposite for this second type of light as compared to the first type of light. For discrimination of the two circular polarization types, a combination of a quarter-lambda plate and a linear polarizer may be used, in which the circularly polarized light is first transformed into linearly polarized light and then filtered by the linear polarizer, and where the orientation of the linear polarizer relative to the fast axis of the quarter-wavelength plate determines which type is being transmitted and/or reflected for detection.

Additionally, the transmitter 10 comprises an encoder (ENC) 16 for encoding input data DI received via an interface circuit (not shown) to obtain a binary data sequence 100 which consists of a sequence of binary values “0” (or “low”) and “1” (or “high”) in accordance with signaling states of a desired communication or interface protocol (e.g., USB 2.0 bus states). The binary data sequence is supplied to a splitter/modulator (SPL/MOD) 18 that generates a driving signal 102 (e.g., driving current or voltage) in accordance with the signaling states of the desired communication or interface protocol (e.g., USB 2.0 bus states) and supplies it to the pair of light sources 12, 14 to generate the light outputs 111, 112 with the different wavelengths l1, l2 or polarizations p1, p2.

Moreover, the light sources 12, 14 may be configured to provide respective feedback signals that indicate respective light output levels or properties or parameters related to these light levels to the splitter/modulator 18, which uses the feedback signal to generate or control the driving signal 102 and apply it to the light sources 12, 14. E.g., based on the feedback signal, the splitter/modulator 18 may adjust the driving signal 102 to control the range and/or level of the driving current supplied to the light sources 12, 14 and thus their respective light outputs 111, 112 in accordance with the modulation scheme.

In an embodiment, the splitter/modulator 18 acts as a modulator driver that converts the binary sequency 100 into to the driving signal 102 to obtain a multi-level driving signal with different levels that represent different states of a communication or interface protocol (e.g., USB 2.0 bus states). Furthermore, the splitter/modulator 18 selects the different levels of the multi-level driving signal 102 to split resultant levels of driving current (or driving voltage) among the pair of the light sources 12, 14 so that each of the light sources 12, 14 is driven by no more than two levels (i.e., discrete values of driving current or driving voltage).

As already explained above, at the receiver 20, the detector 22 may detect the received light signals 111, 112 with different wavelengths l1, l2 or polarizations p1, p2 using the separator 23 (e.g., a wavelength or polarization filter) to separate the received light signals 111, 112 and detect their modulation signal(s) 210. The separator element 23 may be integrated with the photo detector 24 or a set of photo detectors.

There may be one detection channel with subsequent separation of the modulation signals 210 or two different detection channels (i.e., two different photodetectors or photo detector elements) for the two different light types carrying the data.

The separator element 23 may be an optical thin-film filter for filtering the different wavelengths l1, l2 or a polarizer for filtering the different polarizations p1, p2. The polarizer may be a linear or circular polarizer configured to let pass through light waves of a specific polarization while blocking light waves of other polarizations. Both types of the separator element 23 may be of a transmissive and/or reflective type. As an example, a dichroic mirror and polarizing beam splitter may be configured to be transmissive for the first light type (l1 or p1) and reflective for the second light type (l2 or p2), while spectral absorption filters and absorption polarizers are of a transmissive nature.

The separated modulation signal(s) 210 (e.g., the extracted levels of the modulated light signals 111, 112) may then be supplied to a demodulator/combiner circuit (DEM/COM) 26 where they are combined and demodulated by converting discriminated output levels into the original states of the communication or interface protocol (e.g., USB 2.0 bus states).

The original states of the communication or interface protocol may then be decoded in a decoder circuit (DEC) 28 to obtain output data DO which should correspond to the original input data (i.e., original binary data sequence) DI supplied to the transmitter 10.

Optionally, an error detection circuit (not shown) may check the output data based on an error detection scheme (e.g., parity checking, cyclic redundancy check (CRC), error correction coding etc.) to determine a transmission quality (e.g., signal-to-noise ratio) of the optical transmission. The checking result may optionally be fed back from the receiver 20 to the transmitter 10 via an optical or other wireless channel as a transmission quality information that can be used by the splitter/modulator 18 to control the driving signal 102.

FIG. 2 shows a flow diagram of transmission procedure with wavelength or polarization multiplexing according to various embodiments.

In a conversion (CONV) step S201, input data is converted into corresponding states of a communication or interface protocol (e.g., USB 2.0 bus states) that is to be used to transmit the input data via an optical link. Then, in a channel splitting (CH-SPL) step S202, the obtained states of the communication or interface protocol are allocated to different levels of a multi-level driving signal (e.g., a multi-level pulse modulated signal) to be supplied to a pair of light sources in a manner so that each light source of the pair of light sources is driven by no more than two of the different levels of the multi-level driving signal. Thereby, the transmission of the states of the communication or interface protocol is split into a first optical transmission (with a first wavelength or a first polarization) via a first channel created by the first light source and a second optical transmission (with a second wavelength or a second polarization) via a second channel created by the second light source.

In a subsequent modulation (MOD) step S203, the multi-level driving signal is supplied to the pair of light sources to modulate light beams of different wavelength or polarization.

Finally, in a transmission (TX) step S204, the pair of light sources transmit their respective modulated light outputs with different wavelength or different polarization via the first and second channels, respectively.

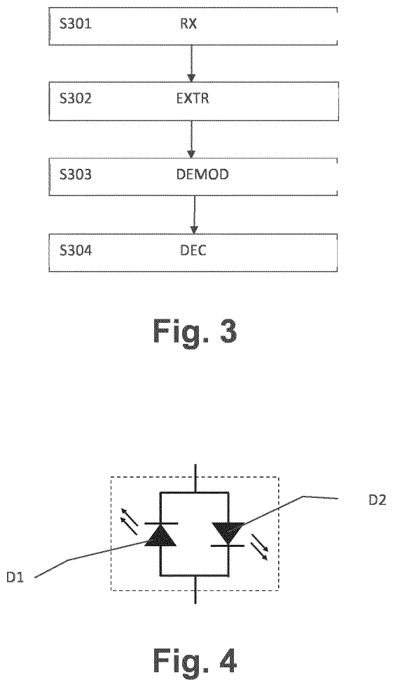

FIG. 3 shows a flow diagram of a reception procedure with wavelength or polarization multiplexing according.

In a reception (RX) step S301, multiplexed optical signals of different wavelengths or polarizations are received (detected) by a detector (which includes at least one photo detector element or at least one set of photo detector elements) of a receiver. In an additional subsequent or prior extraction (EXTR) step S302 which may include a channel separation, the received multiplexed optical signals are separated (e.g., by a wavelength or polarization filter) into two different channel signals and different levels of an original multi-level driving signal are extracted or discriminated from the channel signals.

In a case where the two multiplexed optical signals are modulated with respective different output levels, they may be jointly detected by a single photo detector and the different levels of original multi-level driving signal may be extracted or discriminated from the obtained single joint detection signal.

Then, in a demodulation (DEMOD) step S303 the different levels extracted in step S302 are converted into associated states of a communication or interface protocol (e.g., USB 2.0 bus states).

Finally, in a decoding (DEC) step S304, the obtained states of the communication or interface protocol are decoded into a binary sequency of the original input data.

In an example, a control software may be running on a central processing unit (CPU) provided in the transmitter 10 and/or the receiver 20 to provide at least some of the steps of the transmission and reception procedures discussed in FIGS. 2 and 3.

Portable devices require miniaturization, which can be partly enabled by combining the two light sources 12, 14 of FIG. 1 (e.g., two LED or laser diode (e.g., VCSEL) chips) in a single package. As such chips may be extremely ESD-sensitive, these chips may each be protected by additional Zener diodes. The two different light sources may be mounted in a single package with or without ESD protection by enabling independent addressing of the two different wavelength or polarization channels via four electrodes for fully independent channels or via three electrodes for individually addressable channels with a common anode or a common cathode, respectively.

However, use of the required three or four electrodes leads to a non-optimal miniaturization, particularly if ESD protection by the additional presence of the two Zener diodes is desired.

In an embodiment with optimized miniaturization, the two light sources 12, 14 of FIG. 1 (e.g., LEDs or laser diodes (e.g., VCSELs)) with different wavelengths or polarizations may be mounted antiparallel to enable the desired wavelength or polarization multiplexing functionality while requiring only a two-electrodes package without further inclusion of Zener diodes, as each of the LED or laser diode acts as an ESD protector for the other LED or laser diode against high reverse voltages. Therefore, this configuration results in optimal miniaturization and cost minimization.

FIG. 4 shows schematically a dual-channel emitter or transmitter with antiparallel LEDs or laser diodes D1, D2 according to an embodiment. The antiparallel laser diodes (e.g., VCSELs) D1, D2 correspond to the light sources 12, 14 of FIG. 1.

The antiparallel configuration of the laser diodes D1, D2 provides a polarity-addressable dual channel laser diode configuration enabling wavelength or polarization multiplexing via serial emission of communication negotiation and data signals (e.g., states of a communication or interface protocol) at two different wavelengths, while securing electrostatic discharge (ESD) protection, minimization of component count, and minimization of electrodes count. The polarity of a multi-level driving signal can be used to determine which wavelength or polarization channel is activated.

With the proposed antiparallel LED or laser diode configuration according to various embodiments, in which two LEDs or laser diodes (e.g., VCSELs) with different emission wavelengths (or, alternatively, different polarizations) are driven sequentially, optical wireless communication with more than two output levels can be realized, so that a communication in compliance with the USB protocol or other communication or interface protocols can be achieved while enabling a minimum component count to realize maximum miniaturization for integration in mobile devices.

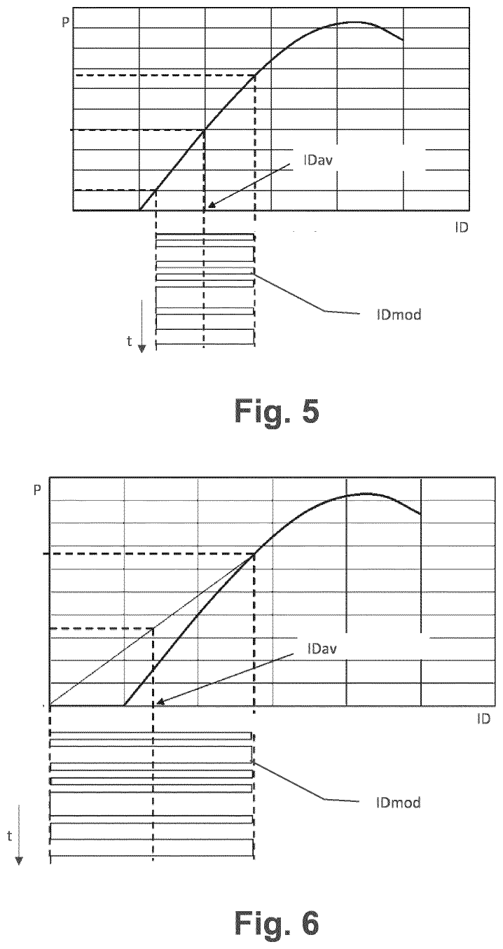

FIG. 5 shows schematically a diagram of a 2-level (PAM-2) non-return-to-zero (NRZ) pulse amplitude modulation for driving a laser diode (e.g., VCSEL) with a lower level just above the lasing threshold current, which is favourable for maximum modulation speed capability.

As can be gathered from FIG. 5, a binary modulated NRZ drive current IDmod with two positive levels around an average drive current IDav is applied to the output power (P) vs. drive current (ID) characteristic of the laser diode to generate a binary modulated NRZ light output with two levels. I.e., the laser diode is switched between two different levels of output light.

FIG. 6 shows schematically a diagram of an OOK amplitude modulation for driving a laser diode.

As can be gathered from FIG. 6, a binary modulated return-to-zero (RZ) drive current IDmod with one positive level and a zero level around an average drive current IDav is applied to the output power (P) vs. drive current (ID) characteristic of the laser diode to generate a binary modulated RZ light output with one non-zero level and a zero level. I.e., the laser diode is switched on and off, as expected from the OOK modulation of the drive current.

Such an OOK modulation using an LED or laser diode (e.g., VCSEL) is beneficial for minimization of power consumption and maximization of efficiency of the transmitter.

With two different wavelengths of emission (wavelength channels), the negotiation and the data transfer of a communication or interface protocol such as the USB protocol can, for instance, be handled by these two wavelength channels respectively, each of which can be modulated using only two power levels. Suitable NIR wavelengths could be e.g. 850 nm and 940 nm, which are wavelengths that are commonly used for NIR devices, but in principle many other wavelengths may be chosen as well. The only requirement is to enable separation of the two wavelengths at the sensor.

Alternatively, the two light sources may be configured to emit light beams of different polarization. A very suitable combination enabling easy separation of the two beams at the receiver would be a right circularly polarized emission and a left circularly polarized emission. However, other combinations of linear or elliptical polarization are possible as well.

A basic configuration enabling optical wireless communication in compliance with communication or interface protocols such as the USB protocol was explained already above in connection with FIG. 4.

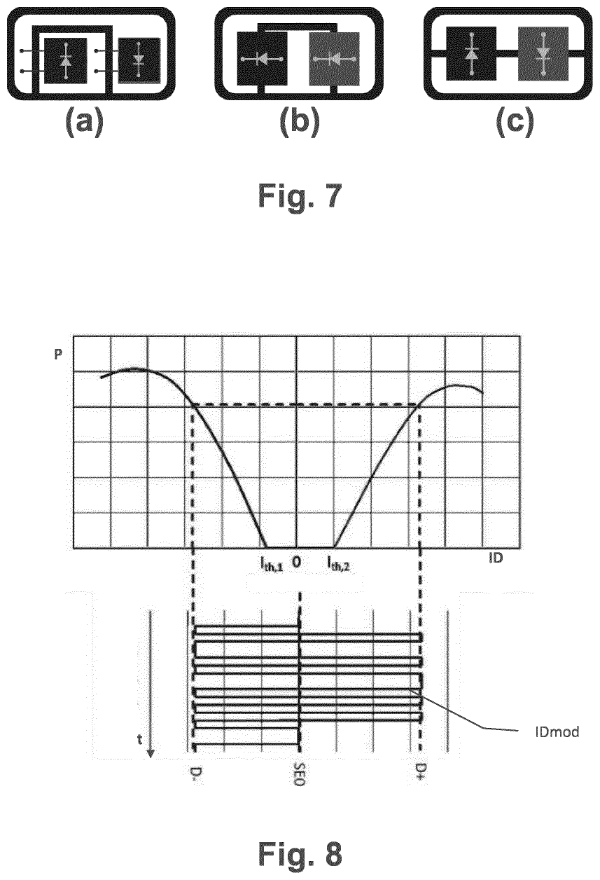

FIG. 7 shows top views of three lay-out examples of two LED or laser diode (e.g., VCSEL) chips configured in an anti-parallel configuration (e.g., on a ceramic substrate) with only two electrodes at the bottom.

The left lay-out example (a) shows a configuration for wire-bonded vertical-architecture chips, while the middle and right lay-out examples (b) and (c) show configurations for flip-chip-architecture chips where the chips are flipped and positioned so that solder balls are facing connectors on an external circuitry. The solder balls are then remelted (typically using hot air reflow). Alternatively, metallic bumps can be used for this interconnect, e.g. Au stud bumps, and a temperature-pressure condition may be applied to realize the actual interconnect. Alternatively, an electrically conductive pressure sensitive adhesive, e.g., an anisotropic electrically conductive pressure sensitive adhesive (PSA), may be used to realize the electrical interconnect.

A ceramic package may be preferred thanks to the superior thermal management capability, as laser diodes (e.g., VCSELs) typically are quite temperature-sensitive elements.

The bottom side of the lay-out examples just comprises two electrodes, galvanically connected to the two electrodes visible as white areas in the top view.

Vertical and flip-chip architectures are depicted here, although also lateral device architectures could be mounted in a similar way using wire bonds for both the anode and the cathode of each laser diode chip.

Alternatively, quad flat no leads (QFN) packages may be applied as a good compromise between package cost and thermal performance. QFN packages are based on a near chip scale plastic encapsulated package made with a planar copper lead frame substrate.

The package may be covered with an optical diffuser plate such as a diffractive optical element to homogenize the light beam profile for each of the light sources of the chips, as well as reduce the source brightness to improve eye-safety by enlarging the virtual source size and increasing the beam angle.

In the following, several embodiments for providing a communication according to a USB protocol with USB 2.0 bus states are described in more detail based on binary states “high” and “low”.

USB was designed to standardize the connection of peripherals to personal computers, both to communicate with and to supply electric power. It has largely replaced interfaces such as serial ports and parallel ports and has become commonplace on a wide range of devices. Examples of peripherals that are connected via USB include computer keyboards and mice, video cameras, printers, portable media players, mobile (portable) digital telephones, disk drives, and network adapters. USB connectors have been increasingly replacing other types as charging cables of portable devices.

USB signals are transmitted using differential signaling, wherein low-speed (LS), full-speed (FS) as well as high-speed (HS) modes use a single data pair, labelled D+ and D−, in half-duplex. Transmitted signal levels are 0.0-0.3 V for logical low, and 2.8-3.6 V for logical high level. USB data is transmitted by toggling data lines between a J state and an opposite K state, while data is encoded using NRZ-inverted (NRZI) line coding. A further state “SE0” (both D+ and D− are low) can be used to indicate an end of a packet signal or a detached USB device.

In a first embodiment, the J state (D+ low, D− high) of the USB protocol is defined by a high output level of the first light source (VCSEL 1) of the antiparallel pair, while the K state (D+ high, D− low) is defined by a high output level of the second light source (VCSEL 2) of the antiparallel pair.

As the combination of both D+ and D− being high is not required in the USB protocol, both light sources of the antiparallel pair would never need to be activated both at the same time unless the low state would for both light sources mean a drive current unequal to zero.

Therefore, only the states (D+ high, D− low), (D+ low, D− high), and (D+ low, D− low) are required, which can be implemented with serial activation/de-activation of the two wavelength or polarization channels of the pair of light sources. In the configuration of the first embodiment, the state SE0 is equal to absence of any signal.

A possible implementation is shown in the following Table 1:

| State | D+ | D− | VCSEL 1 | VCSEL 2 |
|---|---|---|---|---|
| “SE0” | Low | Low | Low = Off | Low = Off |
| “J” | Low | High | High | Low = Off |
| “K” | High | Low | Low = Off | High |

A visualization of the driving conditions upon modulation of such system is presented in FIG. 8.

FIG. 8 shows schematically a diagram of the power vs. drive current characteristics of two antiparallel laser diodes which are driven by a 3-level modulation scheme according to the first embodiment. Both laser diodes are driven by a modulated drive current IDmod in OOK mode, wherein the drive current IDmod is switched in an NRZ manner between a positive level (corresponding to D+) and a negative level (corresponding to D−), while the zero level corresponds to the state SE0. The waveform of the drive current is depicted in FIG. 8 with a time axis in the vertical direction.

In response to the NRZ modulation of the drive current IDmod, the laser diodes are alternatively switched on and off when the modulated drive current IDmod passes through their respective threshold currents I_{th,1} and I_{th,2}.

Although extremely simple for its implementation, the SE0 state can't be discriminated from a loss of the line of sight at the receiver. In addition, this configuration only works for emitters that show a sufficiently low turn-on delay time as the two laser diodes (VCSEL1, VCSEL2) are continuously alternatingly addressed (switched) during data package transfer.

In a second embodiment, the two wavelength or polarization channels of the antiparallel pair of laser diodes (e.g. VCSELs) are driven according to a scheme in which the actual data signals (i.e., the J and K state) have one polarity relative to the two electrodes of the laser diode (e.g. VCSEL) package (i.e., are both emitted by the same laser diode with the same emission wavelength or polarization), and the further communication negotiation signals (i.e., state SE0 and possibly other communication signals) have the opposite polarity (i.e., are emitted by the other laser diode at a wavelength or polarization different from that of the data signals). Also here, the signals are sequentially distributed in time, in analogy with the sequential distribution of these signals as present in the USB 1.1 or USB 2.0 communication protocol.

However, in this case a non-return-to-zero (NRZ) PAM-2 modulation is applied to the first laser diode (VCSEL 1), while OOK modulation is applied to the second laser diode (VCSEL 2). All actual data communication still runs via two virtual D+/D− lines, but the negotiation signals are communicated at least partly at a different wavelength or polarization.

A possible driving scheme is shown in Table 2 below, as an example of a driving scheme for two anti-parallel mounted laser diodes (e.g. VCSELs) enabling optical data communication in compliance with the USB protocol, in which the first laser diode (VCSEL 1) is operated in PAM-2 NRZ mode defining the J and K states, and the second laser diode (VCSEL 2) is operated in OOK mode to define the SE0 state:

| State | D+ | D− | VCSEL 1 | VCSEL 2 |
|---|---|---|---|---|
| “SE0” | Low | Low | Off | High |
| “J” | Low | High | Low | Low = Off |
| “K” | High | Low | High | Low = Off |

Thus, in this configuration, (high) activation of the second laser diode (VCSEL 2) indicates the SE0 state, while the J and K states are indicated by the two non-zero levels of the first laser diode (VCSEL 1). This driving scheme is visualized in FIG. 9.

FIG. 9 shows schematically a diagram of a 3-level non-return-to-zero (NRZ) modulation scheme according to the second embodiment where one of the antiparallel laser diodes with different wavelengths or polarizations is driven in PAM-2 (NRZ) mode and the other laser diode is driven in OOK mode.

As can be gathered from FIG. 9, the OOK component of the modulated drive signal IDmod for the second laser diode (VCSEL 2) which corresponds to the right P vs. ID characteristic of the diagram is used to signal the SE0 state, while the J and K states (D+ and D− levels) are signaled by the two levels of the PAM-2 component of modulated drive signal IDmod for the first laser diode (VCSEL 1) which corresponds to left P vs. ID characteristic of the diagram.

This configuration has the potential advantage of high signal integrity with respect to jitter (i.e., signal timing) thanks to the fact that for all J-K transitions the signal level change is very fast due to the continuous operation of the first laser diode (VCSEL 1) above its threshold I_{th,1} during subsequent J-K transmissions.

Alternatively, in a third preferred embodiment, the two wavelength or polarization channels are linked to the two different data lines D+ and D− as defined in the USB protocol and in line with the first embodiment, but now the SE0 state is indicated by presence of a signal from one of the antiparallel pair of laser diodes.

An implementation would for instance be to directly associate the D+ line with the first laser diode (VCSEL 1) and the D− line with the second laser diode (VCSEL 2), while driving the first laser diode (VCSEL 1) in an NRZ PAM-2 modulation mode and the second laser diode (VCSEL 2) in an OOK modulation mode.

Table 3 below represents an example of a driving scheme for two anti-parallel mounted laser diodes (e.g., VCSELs) enabling optical data communication in compliance with the USB protocol, in which the wavelength or polarization is linked to the USB data lines (i.e., D+/D− communication channels) and one of the antiparallel laser diodes is operated in NRZ PAM-2 modulation mode enabling an additional level for signaling the SE0 state:

| State | D+ | D− | VCSEL 1 | VCSEL 2 |
|---|---|---|---|---|
| “SE0” | Low | Low | Low | Low = Off |
| “J” | Low | High | Off | High |
| “K” | High | Low | High | Low = Off |

As stated before, it may be advantageous to enable a (low, low) state that can be discriminated from the absence of both output signals, e.g., to easily detect a loss of the optical connection. However, for highest signal-to-noise ratio (SNR), the actual data signals as represented by the J and K state should be as high as possible.

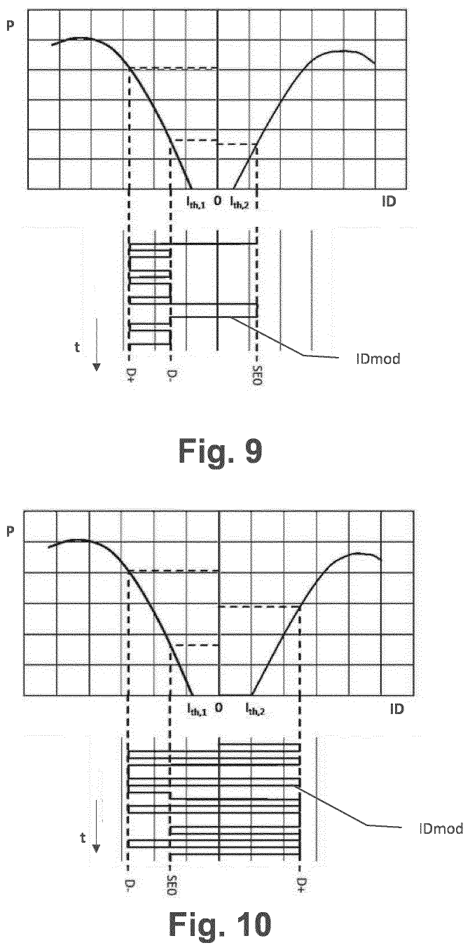

To achieve this, the logical (low, low) state is represented by a single light source of the antiparallel pair being in a non-zero-power mode while the other light source is in a zero-power mode. For the detection of a loss of the line-of-sight no high-frequency modulation is required and the signal can be detected with a lower bandwidth and hence with higher sensitivity. It is therefore proposed to define again the (D+ low, D− low) state as the state in which one of the light sources is OOK modulated while the other light source is PAM-2 modulated with both levels non-equal to zero, but now assign the low level of the PAM-2 modulated light source to the SE0 state such that high optical powers are available for the J and K state (i.e., D− or D+ high). An example of such driving scheme is presented in FIG. 10.

FIG. 10 shows schematically a diagram of a 3-level NRZ modulation scheme according to the third embodiment where one of the laser diodes (left P vs. ID characteristic) is driven in PAM-2 (NRZ) modulation mode and the other laser diode (right P vs. ID characteristic) is driven in OOK modulation mode. Thus, a dual wavelength or dual polarization pair of laser diodes is driven in a 3-level NRZ modulation scheme where a non-zero low level of the PAM-2 modulation defines the SE0 state.

Moreover, the 3-level modulation scheme of the third embodiment could be used for operating both light sources 12, 14 of FIG. 1 with same wavelengths and same polarizations. Here, three different levels of output power of the two light sources 12, 14 are allocated to D+, D− and SE0. Thus, all three different level can be discriminated at the receiver with the detector 22 which would then receive a combined or mixed light signal with three different power levels at one wavelength or polarization.

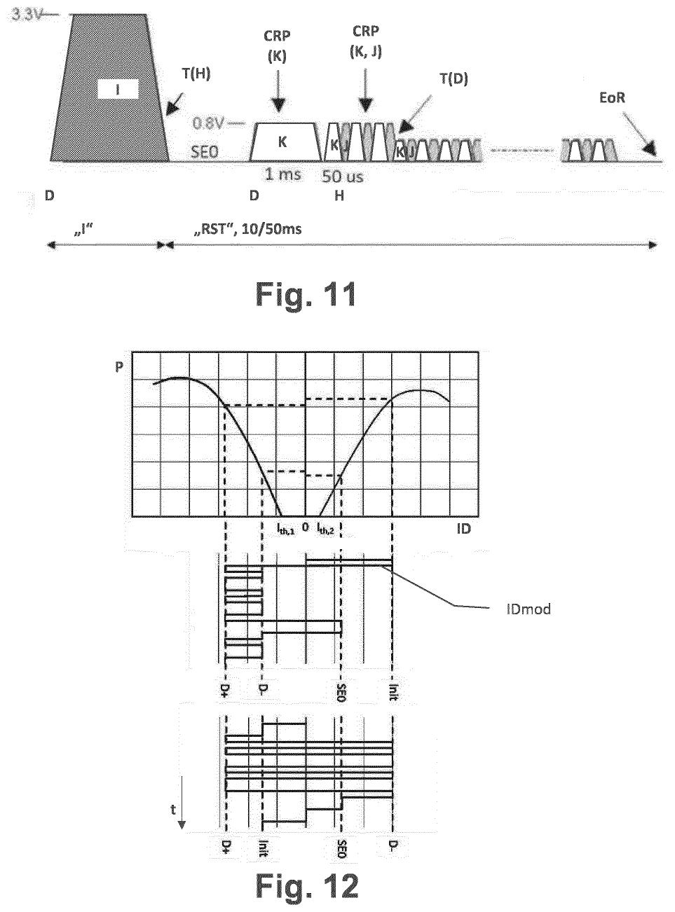

In alternative embodiments, both laser diodes may be driven in NRZ PAM-2 mode. This enables the use of an additional signal level which may be beneficial for communication negotiation messages as required in the full USB-2 protocol. In this way an additional signaling option is enabled that may be used e.g. at a higher than nominal emission power, as this kind of signals are only incidentally used and not repetitively as in the data packages. In the USB communication negotiation, not only fixed J, K, and SE0 signal levels are used, but also terminating impedances and applied currents are adapted. A typical high-speed negotiation procedure is indicated in FIG. 11.

FIG. 11 shows schematically a waveform diagram of an example of a high-speed USB 2.0 negotiation procedure between a host (H) and a device (D) showing signal voltages versus time. The signals on the D+ and D− lines are represented by grey color (D+) and white color (D−), respectively. The signal voltages of the logical high states of the D+ and D− lines may be impacted by termination resistances of the lines by the host and the device.

The waveform diagram of FIG. 11 shows a special protocol during reset (called chirping) that is used to negotiate a high speed (HS) mode with the host or hub (H). A device (D) that is high speed capable first connects as a full speed device (D+ pulled high) in an “IDLE” (“I”) state. Upon receiving a USB RESET (“RST”) where both D+ and D− are driven low (SE0 state) by the host for 10 to 20 ms (host termination T(H)), the device pulls the D− line high for 1 ms, known as chirp K (CRP (K)). This indicates to the host that the device is a high-bandwidth device. If the host/hub is also HS capable, it chirps (CRP(K, J)) by returning alternating J and K states on D− and D+ lines for 50 ms each to let the device know that the hub operates at high bandwidth. The device has to receive at least three sets of KJ chirps before it changes to high-speed terminations (T(D)) and begins high speed signaling until the end of the RESET period (“EoR” in FIG. 11).

According to FIG. 11, there is, apart from timing variation, an initial device state with high voltage that in response may be changed by the host (H), while there is additionally a differentiation between two different signal levels due to line termination during J/K signal transfer. In addition, for the mini/micro connectors for USB 1.0 & USB 2.0, an additional pin has been defined to identify (define) host and slave in USB on-the-go (OTG) connections.

Various sequential schemes could be identified for a full communication negotiation procedure, but all will have in common that more than the requested three states (J, K, SE0) are needed. At least one additional state can be created by enabling NRZ PAM-2 modulation for both emitters, as shown in FIG. 12 below. Such signal may be used for initialization and/or to signal acknowledgement. Such driving scheme for sequential half-duplex wireless optical communication is presented in Table 4 below, which represents an example of a driving scheme for two anti-parallel mounted laser diodes (e.g. VCSELs) enabling sequential single-duplex optical data communication using the three standard USB states and an additional state for signaling of initialization (“I”) and/or acknowledgement (“A”) by an additional emitter status, enabled by driving both light sources (laser diodes) in NRZ PAM-2 mode.

TABLE 4

| State | D+ | D− | VCSEL 1 | VCSEL 2 |
|---|---|---|---|---|
| “SE0” | Low | Low | Low | Off |
| “J” | Low | High | Off | Low |
| “K” | High | Low | High | Off |
| “I” or “A” | | | Off | High |

In this scheme, the J state has been chosen deliberately at the low output level of the second laser diode (VCSEL 2), as the J state is the standard state representing the resume mode and therefore is important for the power consumption when not actively transferring data.

A graphical visualization of some driving schemes using two antiparallel light sources each modulated via NRZ PAM-2 is presented in FIG. 12.

FIG. 12 shows schematically a diagram of a 4-level NRZ modulation scheme where both laser diodes are driven by a modulated drive current IDmod in PAM-2 (NRZ) mode. Apart from the standard J, K, and SE0 signals, an additional “Init” signal can be realized. Two different assignments of signal levels to defined states are indicated at the time-dependent waveforms of the modulated drive current IDmod as examples at the bottom of FIG. 12.

The diagram shows to possible implementation options for the assignment of four states to the operating conditions of the emitters. In a first example, the J and K states are defined by the two levels of the first light source (left P vs. ID characteristic), while the SE0 and an Init state are defined by the two levels of the second light source (right P vs. ID characteristic). In a second example, the J and K states are defined by the highest levels of both light sources, while the SE0 and Init states are defined by the low levels of both light sources. Other permutations in the assignment are possible as well.

Of course, in further embodiments additional, higher, signal levels could be assigned. This may be beneficial in particular for incidentally required signaling.

It is noted that the receiver 20 of FIG. 1 may comprise only a single photo detector 24 as long as different light output levels are used for all protocol states (e.g. PAM-3 or PAM-4) or in the photo detector shows substantially different sensitivity for the two different light emissions or signals resulting in different detected signal levels although some emitted optical power levels may be substantially equal (and the two signal types are only differentiated in wavelength and/or polarization). Then, the detector 22 can discriminate all levels even if both optical signals are jointly detected by the single photo detector 24 without prior separation of the light outputs 111, 112. Moreover, if both optical channel signals are detected by a single photo detector 24, the separator element 23 can be connected to output of the photo detector 24 to extract/discriminate the modulation levels from the single joint/combined detection signal. However, the “single” photo detector 24 may still comprise multiple detector elements to derive further information like e.g. direction of reception of the light beam.

In the case of using a single photo detector 24, the light sources 12, 14 may use same or different wavelengths or polarizations.

With a wavelength-dependent spectral sensitivity of the photo detector 24 a received first wavelength may result in a different detector current than a received different second wavelength. If this difference is sufficient, the modulation levels of wavelength-multiplexed light outputs 111, 112 can be discriminated even if the modulation levels are identical or similar. This also applies if a sufficient polarization-dependent sensitivity of the photo detector can be provided.

Thus, in the above examples of a single photo detector, the advantage of using only two modulation levels per light source remains. The optical transmission signal is divided over two light sources, meaning that the power dissipation is also split over these two light sources and the junction temperatures will stay lower, which is advantageous for the efficiency of the emitters.

However, in particular at the receiver side, a dual-stage detection rather than PAM-3 or PAM-4 detection may be advantageous, because in mobile configurations the distance and relative orientations of the devices may change significantly, resulting in large variations of the absolute (detected) signal levels. For level-discrimination therefore a calibration is needed at the detector side, which is easy if there is only one non-zero level and increases in difficulty with increasing (non-zero) levels (as one needs to know which of the signal levels is received for such calibration). Based on such calibration, the signal amplification can be set to achieve electrical signals with a proper amplitude and better signal-to-noise ratio (SNR).

To summarize, a transmission system for optical communication has been described, that comprises multiplexing of different light sources (e.g., with different wavelengths and/or polarizations) with serial emission of data and protocol negotiation signals to enable binary pulse modulation with miniaturized components. Mounting two different light sources (e.g., VCSELs) antiparallel enables multiplexing functionality while requiring only a two-electrodes package without further inclusion of Zener diodes, resulting in maximum miniaturization and cost minimization.

While the invention has been illustrated and described in detail in the drawings and foregoing description, such illustration and description are to be considered illustrative or exemplary and not restrictive. The invention is not limited to the disclosed embodiments. The proposed wavelength or polarization multiplexing concept can be applied to other types of optical networks and with other types of access devices, modems and transceivers. In particular, the invention is not limited to LiFi-related environments, such as the ITU-T G.9961, ITU-T G.9960, and ITU-T G.9991 network environment. It can be used in visible light communication (VLC) systems, IR data transmission systems, G.vlc systems, connected lighting systems, OWC systems, and smart lighting systems.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

The described procedures like those indicated in FIGS. 2 and 3 can be implemented as program code means of a computer program and/or as dedicated hardware of the receiver devices or transceiver devices, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. A transmitter for transmitting multiplexed optical signals in an optical communication system, wherein the transmitter comprises:
two semiconductor light sources; and
an apparatus for transmitting data via an optical link, the apparatus comprising:
an encoder for converting input data into a plurality of signaling states of a communication or interface protocol; and
a driver for generating at least one modulated driving signal with a plurality of modulation levels mapped to the plurality of signaling states and for supplying the at least one modulated driving signal to the two semiconductor light sources, wherein the modulated driving signal is configured to drive the two semiconductor light sources with different ones of the plurality of modulation levels, in a mutually exclusive manner, such that only one of the semiconductor light sources emits at a time.

2. The transmitter of claim 1, wherein the two semiconductor light sources are configured to generate respective light outputs with different wavelength or polarization.

3. The transmitter of claim 1, wherein the two semiconductor light sources are selected from: light emitting diodes (LEDs), micro LEDs, vertical cavity surface emitting lasers, edge emitting lasers, edge emitting laser didoes, and photonic crystal surface emitting lasers.

4. The transmitter of any one of claim 1, wherein the two semiconductor light sources are connected in an antiparallel configuration with two connectors for applying one modulated drive signal to both of the two semiconductor light sources and the one modulated driving signal is a bipolar modulated driving signal.

5. The transmitter of claim 4, wherein the antiparallel configuration is implemented using a vertical chip architecture, a lateral chip architecture, or a flip-chip architecture, mounted on a substrate or in a package such as a (quad) flat no leads package, QFN, a plastic leaded chip carrier package, PLCC, or a ceramic or ceramic-substrate package.

6. The transmitter of claim 4, wherein the plurality of signaling states of the communication or interface protocol are used to enable driving of each of the semiconductor light sources using only two power levels for generating protocol negotiation signals and data transfer signals.

7. The transmitter of 6, wherein the communication or interface protocol is a Universal Serial Bus, USB, protocol.

8. The transmitter of claim 7, wherein the plurality of signaling states comprise at least some of a J state, a K state, a SE0 state, and an Init state of the USB protocol.

9. The transmitter of claim 1, wherein the driver is configured to generate the modulated drive signal by using one of:
a three-level modulation scheme where both semiconductor light sources are driven in an on off keying, OOK, mode;
a three-level non-return-to-zero, NRZ, modulation scheme where one of the two semiconductor light sources is driven in a two-level NRZ pulse amplitude modulation, PAM-2, mode and the other one of the two laser diodes is driven in the OOK mode; or
a four-level NRZ modulation scheme where both light sources are driven in the NRZ PAM-2 mode.

10. A system for transmitting data via an optical link, the system comprising:
a transmitter in accordance with claim 1 and
an apparatus for receiving the data via the optical link, the apparatus comprising:
a detector for detecting multiplexed optical signals with the different ones of the plurality of modulation levels and for extracting the plurality of modulation levels; and
a demodulator for converting the plurality of modulation levels into the plurality of signaling states of the communication or interface protocol.

11. The system of claim 10, wherein the multiplexed optical signals are wavelength or polarization multiplexed optical signals.

12. A method of transmitting data via an optical link, the method comprising:
converting input data into a plurality of signaling states of a communication or interface protocol;
generating at least one modulated driving signal with a plurality of modulation levels mapped to the plurality of signaling states; and
supplying the at least one modulated driving signal to two semiconductor light sources, wherein the modulated driving signal is configured to drive the two semiconductor light sources with different ones of the plurality of modulation levels in a mutually exclusive manner, such that only one of the light semiconductor source emits at a time.

13. The method of claim 12, wherein the two semiconductor light sources are selected from:
light emitting diodes (LEDs), micro LEDs, vertical cavity surface emitting lasers, edge emitting lasers, edge emitting laser didoes, and photonic crystal surface emitting lasers.

14. The method of claim 13, wherein the two semiconductor light sources are in an antiparallel configuration with two connectors for applying one modulated drive signal to both of the two light sources and the one modulated driving signal is a bipolar modulated driving signal.
